(19) United States
(12) Patent Application Publication
(10) Pub. No.: US 2026/0346842 A1
(43) Pub. Date: Nov. 5, 2026

(54) INTERNET OF THINGS (IOT) SYSTEMS AND METHODS FOR DYNAMIC INVERSION OF ROAD FRICTION BASED ON MULTIPLE SENSORS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Jun WANG, Chengdu (CN); Chang SU, Chengdu (CN); Zilin CHEN, Chengdu (CN)

(73) Assignee: CHENGDU QINCHUAN IOT TECHNOLOGY CO., LTD., Chengdu (CN)

(21) Appl. No.: 19/711,914

(22) Filed: Jun. 17, 2026

(30) Foreign Application Priority Data
Apr. 10, 2026 (CN) 202610468347.1

(51) Int. Cl. B60W 30/14; B60W 50/14; G16Y 40/10; H04W 4/46

(52) U.S. Cl. CPC B60W 30/143; B60W 50/14; G16Y 40/10; H04W 4/46; B60W 2520/16; B60W 2520/18; B60W 2520/26; B60W 2520/30; B60W 2552/40; B60W 2555/20; B60W 2556/20; B60W 2556/35; B60W 2556/65

(57) ABSTRACT

An IoT system and a method for dynamic inversion of road friction based multiple sensors are provided. The system includes a management platform, a vehicle-road cooperative network, and vehicle terminals. Each vehicle terminal is configured to: for a corresponding wheel, determine an adhesion coefficient of a contact point between the wheel and a road surface; and determine a confidence level of the adhesion coefficient based on a slip ratio of the wheel. The management platform is configured to: obtain vehicle travel information of each vehicle terminal, adhesion coefficients corresponding to wheels of a vehicle terminal, and confidence levels of the adhesion coefficients; and determine a fused adhesion coefficient and transmit the fused adhesion coefficient to each vehicle terminal. Each vehicle terminal is further configured to: determine a target travel speed of the vehicle, and drive the vehicle to the target travel speed within a target time.

### CROSS-REFERENCE TO RELATED APPLICATIONS

This application claims priority to Chinese Patent Application No. 202610468347.1, filed on Apr. 10, 2026, the entire contents of which are hereby incorporated by reference.

### TECHNICAL FIELD

The present disclosure relates to the field of vehicle road safety, and in particular, to IoT systems and methods for dynamic inversion of road friction based on multiple sensors.

### BACKGROUND

A friction force between a wheel and a road surface determines physical limits of vehicle acceleration, braking, and steering, and serves as one of core parameters for safety decision-making in an autonomous driving system. Currently, visual sensors such as cameras and lidars are mainly relied upon to identify areas of standing water, snow, or ice. However, due to limitations of illumination, occlusion, and visual blind spots, a friction force cannot be quantitatively acquired, and data acquisition exhibits a significant lag. Estimation manners based on a wheel speed have large errors under complex road conditions, making it difficult to form global, shareable high-precision road surface state data.

Therefore, there is an urgent need to provide a IoT system and a method for dynamic inversion of road friction based on multiple sensors, so as to solve the problems of existence of visual blind spots, inability to quantify a friction force, large estimation errors, and difficulty in global warning, thereby providing highly reliable road surface state data support for high-level autonomous driving and intelligent transportation.

### SUMMARY

One or more embodiments of the present disclosure provide an IoT system for dynamic inversion of road friction based on multiple sensors, comprising a management platform, a vehicle-road cooperative network, and a plurality of vehicle terminals, wherein each of the plurality of vehicle terminals is configured to: for each wheel corresponding to the vehicle terminal, determine an adhesion coefficient of a contact point between the wheel and a road surface based on multi-dimensional mechanical data of the wheel; and determine a confidence level of the adhesion coefficient based on a slip ratio of the wheel; and the management platform is configured to: obtain, via the vehicle-road cooperative network, vehicle travel information of each of the plurality of vehicle terminals, a plurality of adhesion coefficients corresponding to a plurality of wheels, and a plurality of confidence levels of the plurality of adhesion coefficients; and determine, based on the vehicle travel information of the plurality of vehicle terminals, the plurality of adhesion coefficients, and the plurality of confidence levels, a fused adhesion coefficient corresponding to a grid area and transmit the fused adhesion coefficient to each of the plurality of vehicle terminals; and each of the plurality of vehicle terminals is further configured to: determine a target travel speed of a vehicle based on the fused adhesion coefficient, and drive the vehicle to the target travel speed within a target time.

One or more embodiments of the present disclosure provide a method for dynamic inversion of road friction based on an Internet of Things (IoT) and multiple sensors, the method being performed by a system for dynamic inversion of road friction based on the IoT and the multiple sensors, the system comprising a management platform, a vehicle-road cooperative network, and a plurality of vehicle terminals; the method comprising: performing, by each of the plurality of vehicle terminals, operations including: for each wheel corresponding to the vehicle terminal, determining an adhesion coefficient of a contact point between the wheel and a road surface based on multi-dimensional mechanical data of the wheel; and determining a confidence level of the adhesion coefficient based on a slip ratio of the wheel; performing, by the management platform, operations including: obtaining, via the vehicle-road cooperative network, vehicle travel information of each of the plurality of vehicle terminals, a plurality of adhesion coefficients corresponding to a plurality of wheels, and a plurality of confidence levels of the plurality of adhesion coefficients; and determining, based on the vehicle travel information of each of the plurality of vehicle terminals, the plurality of adhesion coefficients, and the plurality of confidence levels, a fused adhesion coefficient corresponding to a grid area and transmitting the fused adhesion coefficient to each of the plurality of vehicle terminals; and performing, by each of the plurality of vehicle terminals, operations including: determining a target travel speed of a vehicle based on the fused adhesion coefficient, and driving the vehicle to the target travel speed within a target time.

### BRIEF DESCRIPTION OF THE DRAWINGS

The present disclosure will be further elucidated by way of exemplary embodiments, which are described in detail with reference to the accompanying drawings. These embodiments are not limiting. In these embodiments, the same reference numerals denote the same structures, wherein:

FIG. 1 is a schematic diagram of a platform architecture of an IoT system for dynamic inversion of road friction based on multiple sensors according to some embodiments of the present disclosure.

FIG. 2 is a flowchart of an exemplary process for dynamic inversion of road friction based on an Internet of Things (IoT) and multiple sensors according to some embodiments of the present disclosure.

FIG. 3 is a flowchart of an exemplary process for determining a fused adhesion coefficient according to some embodiments of the present disclosure.

FIG. 4 is an exemplary schematic diagram of a subsequent processing flow after receiving warning information according to some embodiments of the present disclosure.

### DETAILED DESCRIPTION

To more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose. The term “and/or”, as used herein, is merely a way of describing the associative relationship of an associated object, indicating that three relationships may exist, e.g., A and/or B, which may be represented as: A alone, both A and B, and B alone.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

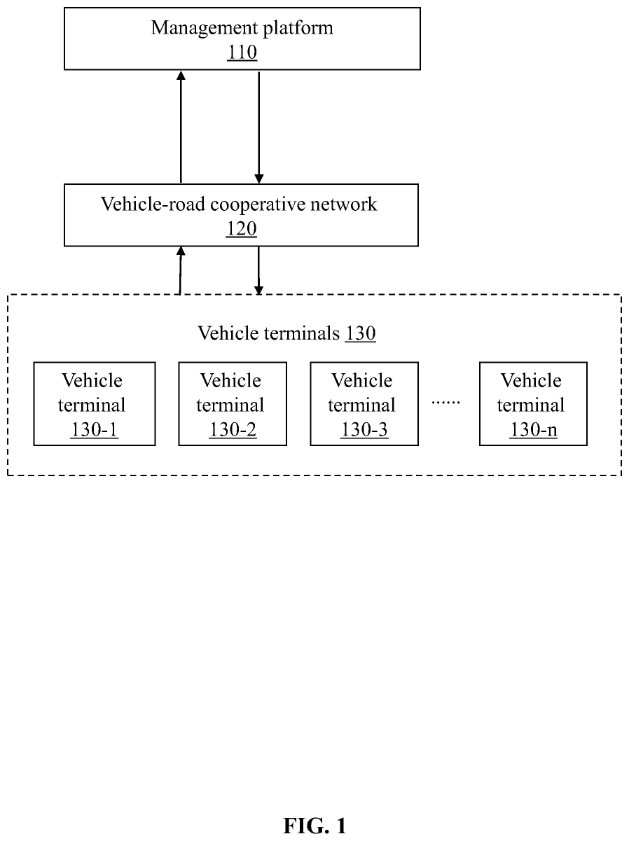

FIG. 1 is a schematic diagram of a platform architecture of a an IoT system for dynamic inversion of road friction based on multiple sensors according to some embodiments of the present disclosure.

In some embodiments, as shown in FIG. 1, an IoT system 100 for dynamic inversion of road friction based on multiple sensors (also referred to as an IoT system 100 or a system 100) may include a management platform 110, a vehicle-road cooperative network 120, and vehicle terminals 130, wherein the vehicle terminals 130 may include a plurality of vehicle terminals (130-1, 130-2, . . . , 130-n).

The management platform 110 refers to a comprehensive management platform that manages, coordinates, and orchestrates connections and collaborations among a plurality of platforms. In some embodiments, the management platform 110 is configured as a server or a processor.

In some embodiments, the management platform 110 is configured to obtain, via the vehicle-road cooperative network, vehicle travel information of each of the plurality of vehicle terminals, a plurality of adhesion coefficients corresponding to a plurality of wheels, and a plurality of confidence levels of the plurality of adhesion coefficients; and determine, based on the vehicle travel information of each of the plurality of vehicle terminals, the plurality of adhesion coefficients, and the plurality of confidence levels, a fused adhesion coefficient corresponding to a grid area and transmit the fused adhesion coefficient to each of the plurality of vehicle terminals.

The vehicle-road cooperative network 120 refers to a wireless communication network system used for interaction among various platforms. In some embodiments, the vehicle-road cooperative network 120 is configured as a communication network or a gateway.

In some embodiments, the management platform 110 is communicatively connected to the vehicle terminals 130 via the vehicle-road cooperative network 120 to achieve data interaction.

In some embodiments, the vehicle-road cooperative network 120 may include communication modes such as Vehicle-to-Vehicle (V2V), Vehicle-to-Infrastructure (V2I), and Vehicle-to-Network (V2N). In some embodiments, the vehicle-road cooperative network 120 may support communication protocols such as C-V2X, DSRC, and 5G.

The vehicle terminals 130 (including 130-1, 130-2, . . . , 130-n) refer to intelligent connected vehicle terminals equipped with sensors. In some embodiments, a vehicle terminal may include a control module, an on-board communication module (e.g., an On-Board Unit, OBU), an in-wheel motor, a steering motor, a plurality of mounted sensors (such as a mechanical sensor and a wheel speed sensor), an Inertial Measurement Unit (IMU), and a positioning module (e.g., a GPS positioning system), etc. The control module refers to a core module through which the vehicle terminal performs control, for example, an electronic control device such as a Micro-Controller Unit (MCU).

In some embodiments, each of the plurality of vehicle terminals is configured to: for each wheels, determine an adhesion coefficient of a contact point between the wheel and a road surface based on multi-dimensional mechanical data of the wheel, and determine a confidence level of the adhesion coefficient based on a slip ratio of the wheel.

In some embodiments, each of the plurality of vehicle terminals is further configured to: determine a target travel speed of a vehicle based on the fused adhesion coefficient, and drive the vehicle to the target travel speed within a target time.

In some embodiments of the present disclosure, the system 100 can form a closed-loop information flow of “sensing-fusion-decision-execution-maintenance” among the vehicle terminals, the vehicle-road cooperative network, and the management platform, and operate collaboratively under unified scheduling of the system, thereby realizing full-process informatization, unmanned operation, and intelligentization of dynamic monitoring of adhesion coefficients, warning, and maintenance operations, and significantly improving driving safety and road traffic efficiency under severe weather conditions.

It should be noted that the above descriptions of the system for dynamic inversion of road friction based on an Internet of Things (IoT) and multiple sensors and the platforms thereof are merely provided for convenience of description and are not intended to limit the present disclosure to the scope of the illustrated embodiments. It may be understood that, for those skilled in the art, after understanding the principles of the system, various platforms may be arbitrarily combined, or subsystems may be formed and connected to other platforms without departing from such principles.

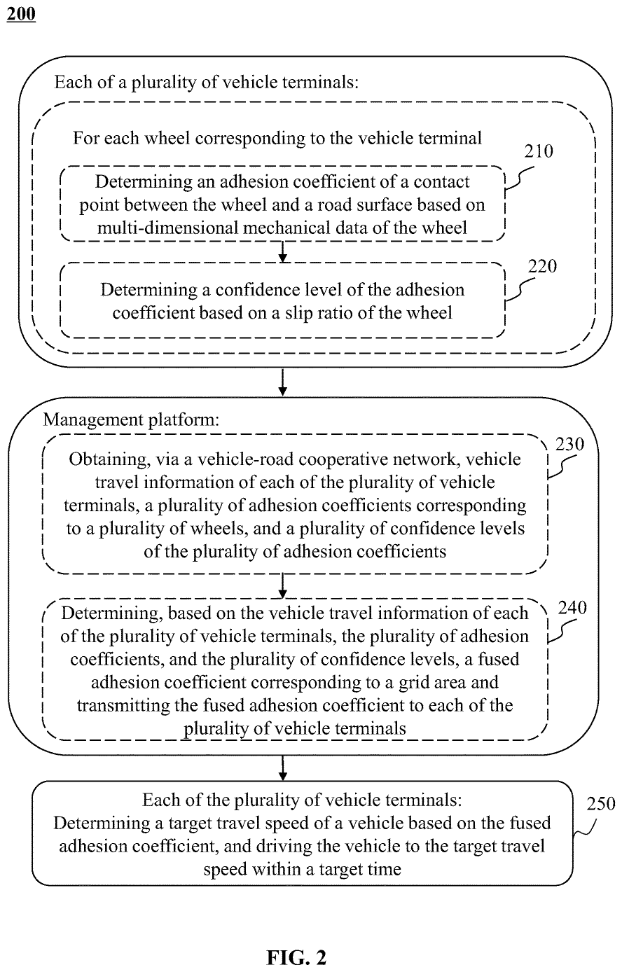

FIG. 2 is a flowchart of an exemplary process for dynamic inversion of road friction based on an Internet of Things (IoT) and multiple sensors according to some embodiments of the present disclosure.

In some embodiments, an exemplary process of a method for dynamic inversion of road friction based on an Internet of Things (IoT) and multiple sensors may be implemented by the IoT system for dynamic inversion of road friction based on multiple sensors, and is specifically performed by a management platform (e.g., the management platform 110) and a plurality of vehicle terminals. As shown in FIG. 2, a process 200 may include steps 210 to 250.

Step 210, determining, by each of a plurality of vehicle terminals, for each wheel corresponding to the vehicle terminal, an adhesion coefficient of a contact point between the wheel and a road surface based on multi-dimensional mechanical data of the wheel.

The multi-dimensional mechanical data refers to mechanical sensing data of the wheel in contact with the road surface during travel. In some embodiments, the multi-dimensional mechanical data may include a longitudinal force, a normal force, and a lateral force experienced by the wheel in a vehicle body coordinate system.

The contact point refers to a contact point between the wheel and a road surface.

The longitudinal force refers to a pushing/pulling force experienced by the wheel on a longitudinal axis of the vehicle. The longitudinal axis of the vehicle refers to a vehicle axis along a front-rear direction of a vehicle body, denoted as an X*-axis of the vehicle body coordinate system, with a direction from a rear of the vehicle body toward a front of the vehicle body being a positive direction of the X*-axis. A direction of the longitudinal force is along the positive direction of the X*-axis.

The normal force refers to a supporting force at the contact point between the wheel and the road surface, perpendicular to the road surface and directed upward. The direction perpendicular to the road surface and directed upward is denoted as a positive direction of a Z*-axis of the vehicle body coordinate system. A direction of the normal force is along the positive direction of the Z*-axis.

The lateral force refers to a friction force experienced by the wheel on a lateral axis of the vehicle. The lateral axis of the vehicle refers to a vehicle axis along a left-right direction of the vehicle body, denoted as a Y*-axis of the vehicle body coordinate system, with a direction from a left side of the vehicle body toward a right side of the vehicle body being a positive direction of the Y*-axis. A direction of the lateral force is along the positive direction of the Y*-axis.

The vehicle body coordinate system is a three-dimensional coordinate system established with a center of mass of the vehicle or an installation position of an IMU as an origin, and with the X*-axis, the Y*-axis, and the Z*-axis described above as axes.

In some embodiments, the vehicle adopts independently driven in-wheel motors for respective wheels, and the vehicle terminal may directly measure and obtain the multi-dimensional mechanical data of the wheel through an IMU integrated inside a bearing unit of the in-wheel motor.

In some embodiments, each vehicle terminal may further obtain a pitch angle and a roll angle of the vehicle; establish a coordinate rotation matrix of the vehicle based on the pitch angle and the roll angle; and correct the multi-dimensional mechanical data based on the coordinate rotation matrix.

The pitch angle refers to an angle between the longitudinal axis of the vehicle and the road surface.

The roll angle refers to an angle between the lateral axis of the vehicle and the road surface.

In some embodiments, when the vehicle accelerates and raises its head, the pitch angle is a positive value; when the vehicle brakes and lowers its head, the pitch angle is a negative value. When the vehicle tilts to the right, the roll angle is a positive value; when the vehicle tilts to the left, the roll angle is a negative value.

In some embodiments, the vehicle terminal may measure the pitch angle and the roll angle of the vehicle through the IMU.

The coordinate rotation matrix refers to a three-dimensional rotation matrix used to convert data in the vehicle body coordinate system into data in a road coordinate system.

In some embodiments, the vehicle terminal may represent the coordinate rotation matrix based on the pitch angle and the roll angle by the following Formula (1):

$$R = [ \begin{matrix}cos θ & 0 & sin θ \\ sin ϕsinθ & cos ϕ & - sin ϕcosθ \\ - cos ϕsinθ & sin ϕ & cos ϕcosθ\end{matrix} ] , \qquad ( 1 )$$

wherein R represents the coordinate rotation matrix, θ represents the pitch angle, and φ represents the roll angle.

In some embodiments, the vehicle terminal may correct the multi-dimensional mechanical data based on the coordinate rotation matrix by the following Formulas (2) and (3):

Fraw=|FₓF_{y}F_{z}| (2),

Fᵣₑₐₗ=R×Fraw (3),

wherein Fᵣₑₐₗ represents corrected multi-dimensional mechanical data, Fraw represents the multi-dimensional mechanical data, and Fₓ, F_{y}, and F_{z} represent the longitudinal force, the lateral force, and the normal force, respectively.

The corrected multi-dimensional mechanical data refers to multi-dimensional mechanical data in the road coordinate system obtained by converting the multi-dimensional mechanical data in the vehicle body coordinate system.

A rolling forward direction of the wheel on the road surface is a positive direction of an X-axis of the road coordinate system. A direction parallel to the road surface and perpendicular to the rolling forward direction of the wheel pointing toward an outer side of the vehicle body is denoted as a positive direction of a Y-axis of the road coordinate system. A direction perpendicular to the road surface and directed upward is denoted as a positive direction of a Z-axis of the road coordinate system. The road coordinate system is a three-dimensional coordinate system established with the contact point between the wheel and the road surface as an origin, and with the X-axis, the Y-axis, and the Z-axis described above as axes.

In some embodiments of the present disclosure, by correcting the multi-dimensional mechanical data through the coordinate rotation matrix, the problem of inaccurate calculation of the adhesion coefficient when the vehicle accelerates and raises its head or brakes and lowers its head is effectively eliminated, and the accuracy and robustness of the subsequent calculation of the adhesion coefficient under non-uniform-speed travel scenarios are significantly improved.

The adhesion coefficient refers to a coefficient reflecting an adhesion capability of a road surface, i.e., a friction coefficient.

In some embodiments, a value range of the adhesion coefficient is 0 to 1. For example, under conditions with a relatively small friction force such as icy, snowy, or wet road surfaces, the adhesion coefficient is relatively small (e.g., 0.1 to 0.3); under conditions with a relatively large friction force such as dry asphalt or concrete road surfaces, the adhesion coefficient is relatively large (e.g., 0.7 to 0.9).

In some embodiments, for each wheel, the corresponding vehicle terminal may determine the adhesion coefficient of the contact point between the wheel and the road surface based on the multi-dimensional mechanical data of the wheel by the following Formula (4):

$${μ}_{i} = \frac{\sqrt{{F}_{xi}^{2} + {F}_{yi}^{2}}}{{F}_{zi}} , \qquad ( 4 )$$

wherein μᵢ represents an adhesion coefficient corresponding to an i-th wheel; Fₓᵢ represents a longitudinal force experienced by the i-th wheel; F_{yi} represents a lateral force experienced by the i-th wheel; F_{zi} represents a normal force experienced by the i-th wheel; for example, taking a four-wheel vehicle as an example, i=1, 2, 3, 4 (i=1 represents a front-left wheel, i=2 represents a front-right wheel, i=3 represents a rear-left wheel, i=4 represents a rear-right wheel).

In some embodiments, for each wheel, the corresponding vehicle terminal may further: control an in-wheel motor of the wheel to apply an excitation torque; obtain, based on the excitation torque, a frequency response characteristic of a wheel speed of the wheel to the excitation torque; and determine the adhesion coefficient based on the multi-dimensional mechanical data and the frequency response characteristic.

The excitation torque refers to an excitation signal applied by the vehicle terminal to the in-wheel motor. In some embodiments, the excitation signal is a sinusoidal wave or square wave signal with a high frequency (e.g., 50 Hz), a low amplitude (e.g., 5 N·m), and a periodic characteristic (e.g., lasting 2 s).

In some embodiments, the excitation torque may be automatically generated by a control module (e.g., an MCU) of the vehicle terminal. For description of the control module, reference may be made to the related description of FIG. 1.

In some embodiments, the control module of the vehicle terminal periodically applies a small disturbance to the in-wheel motor by superimposing the excitation torque on a normal driving torque, thereby actively exciting a micro-response behavior of the wheel and the contact point between the wheel and the road surface (e.g., an instantaneous slip of 1 mm occurs at the contact point between the wheel and the road surface). The normal driving torque refers to a motor torque required to maintain a current vehicle speed.

The frequency response characteristic refers to a dynamic response characteristic exhibited by the wheel speed under the action of the excitation torque. In some embodiments, the frequency response characteristic may include a response amplitude of the wheel speed, a delay time, a recovery time, etc.

The response amplitude of the wheel speed refers to a variation of the wheel speed after the excitation torque is applied to the in-wheel motor.

The delay time of the wheel speed refers to a time difference between applying the excitation torque to the in-wheel motor and occurrence of the micro-response behavior.

The recovery time of the wheel speed refers to a time duration required for the wheel speed to return to an original state after the micro-response behavior ends.

In some embodiments, the vehicle terminal may obtain, through a high-frequency sampling wheel speed sensor, a wheel speed sequence within a set time window after applying the excitation torque (including wheel speeds at a plurality of time points within the set time window), and analyze the wheel speed sequence through a frequency domain analysis technique (e.g., Fourier transform) to extract the frequency response characteristic of the wheel speed to the excitation torque.

The set time window refers to a time period for performing one frequency domain analysis. In some embodiments, the set time window may be an equivalent time window corresponding to a spatial sampling length. The spatial sampling length refers to a fixed road surface distance required for performing one frequency domain analysis on a road on which the vehicle travels, so as to ensure that each frequency domain analysis covers a fixed distance. The spatial sampling length may be preset manually, for example, 3 meters.

For example, if the spatial sampling length is L, and an absolute longitudinal speed of the vehicle is V, then a length T of the set time window is T=L/V, and the set time window may be a time period having a length of T before a current moment.

The absolute longitudinal speed of the vehicle refers to an instantaneous horizontal speed of a center of mass of the vehicle along the rolling forward direction of the wheel (i.e., the positive direction of the X-axis of the road coordinate system described above). In some embodiments, the absolute longitudinal speed of the vehicle may be obtained through a GPS positioning system of the vehicle.

In some embodiments, the vehicle terminal may determine the adhesion coefficient through a coefficient model based on the multi-dimensional mechanical data and the frequency response characteristic.

The coefficient model refers to a model configured to determine the adhesion coefficient. In some embodiments, the coefficient model may be a machine learning model, for example, a Convolutional Neural Network (CNN), a Recurrent Neural Network (RNN), etc.

In some embodiments, an input of the coefficient model may include the multi-dimensional mechanical data and the frequency response characteristic, and an output of the coefficient model may include the adhesion coefficient.

In some embodiments, the coefficient model may be obtained through training with a large number of first training samples and first labels corresponding to the first training samples. The vehicle terminal may input a plurality of first training samples with first labels into an initial coefficient model, construct a loss function based on the first labels and output results of the initial coefficient model, and iteratively update parameters of the initial coefficient model based on the loss function through a gradient descent or other techniques. When a preset training condition is satisfied, the training is completed, and a trained coefficient model is obtained. The preset training condition may include convergence of the loss function, a count of iterations reaching a threshold, etc.

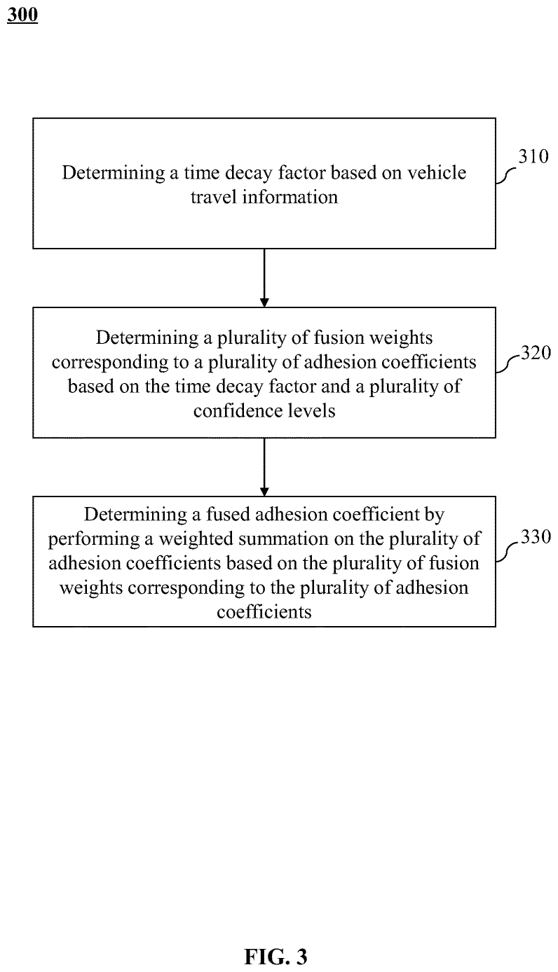

The first training samples may only include sample multi-dimensional mechanical data and sample frequency response characteristics. The first labels are sample adhesion coefficients corresponding to the first training samples. In some embodiments, the first training samples and the first labels may be obtained based on experimental data. For example, a real vehicle experiment may be conducted on a standard test site (e.g., a site covered with typical road surface conditions such as dry asphalt, wet asphalt, compacted snow, or ice): during travel of an experimental vehicle, for each wheel, a corresponding in-wheel motor is controlled to apply an experimental excitation torque, and experimental multi-dimensional mechanical data and an experimental wheel speed of the wheel are collected; an experimental frequency response characteristic of the wheel is extracted through frequency domain analysis, and the experimental multi-dimensional mechanical data and the experimental frequency response characteristic are used as a first training sample; an actual adhesion coefficient corresponding to the experimental vehicle is obtained through a high-precision standard instrument or a professional road friction coefficient test vehicle, and is used as a first label. For description of tire properties, reference may be made to the related description of FIG. 3.

In some embodiments of the present disclosure, by applying an excitation torque to the in-wheel motor to excite a micro-response behavior, active detection of the adhesion coefficient is realized, and the adhesion coefficient is determined by utilizing the frequency response characteristic, thereby overcoming the limitation in identifying a friction capability under non-limit road conditions, improving the real-time performance and accuracy of sensing, and thus enhancing driving safety.

Step 220, determining, by each of the plurality of vehicle terminals, for each wheel corresponding to the vehicle terminal, a confidence level of the adhesion coefficient based on a slip ratio of the wheel. For more related content regarding the confidence level of the adhesion coefficient, reference may be made to the above description.

The slip ratio refers to a ratio of a difference between a wheel speed and a absolute longitudinal speed of the vehicle. In some embodiments, the slip ratio may be represented by a percentage within a range of 0 to 1.

In some embodiments, for each wheel, the corresponding vehicle terminal may determine the slip ratio of the wheel by the following Formula (5):

S=(W−V)/W (5),

wherein S represents the slip ratio, W represents the wheel speed, and V represents the absolute longitudinal speed of the vehicle. For more content regarding the wheel speed and the absolute longitudinal speed of the vehicle, reference may be made to the related description above.

In some embodiments, the slip ratio may be used to determine whether the wheel is in a slipping state (e.g., the wheel is spinning freely or dragging while locked). For example, if the slip ratio is greater than or equal to a preset slip ratio threshold, the wheel is determined to be in the slipping state. The preset slip ratio threshold may be set manually based on historical experience, for example, 20%.

In some embodiments, the closer the slip ratio is to 0, the closer the wheel speed is to the absolute longitudinal speed of the vehicle, and the less likely slipping occurs.

The confidence level of the adhesion coefficient refers to a degree of reliability with which the adhesion coefficient reflects an adhesion capability of the road surface. In some embodiments, the confidence level of the adhesion coefficient may be represented by a numerical value within a range of 0 to 1.

In some embodiments, the vehicle terminal may determine the confidence level of the adhesion coefficient in a plurality of ways based on the slip ratio of the wheel. For example, for a wheel, when the slip ratio of the wheel is less than or equal to a first preset threshold, a friction force between the wheel and the road surface has not yet reached a road surface friction limit, and at this time the confidence level of the adhesion coefficient is set to a low confidence level. When the slip ratio of the wheel is greater than the first preset threshold and less than a second preset threshold, the friction force between the wheel and the road surface is close to the road surface friction limit, and at this time the confidence level of the adhesion coefficient is set to a high confidence level. When the slip ratio is greater than or equal to the second preset threshold, the vehicle may have lost control (e.g., being in the slipping state), and at this time the confidence level of the adhesion coefficient is set to 0. The first preset threshold is less than the second preset threshold. The low confidence level, the high confidence level, the first preset threshold, and the second preset threshold may all be set manually based on historical experience. For example, the first preset threshold is 10%, the second preset threshold may be the same as or approximately the same as the preset slip ratio threshold, e.g., 20%, the low confidence level is 0.2, and the high confidence level is 0.8.

In some embodiments, for each wheel, the corresponding vehicle terminal may further perform a frequency domain analysis on a normal force sequence to determine a frequency domain feature; and determine the confidence level based on the frequency domain feature and the slip ratio.

The normal force sequence refers to a sequence formed by arranging normal forces at a plurality of time points within a set time window in chronological order. For more content regarding the normal force and the set time window, reference may be made to the related description above.

The frequency domain feature refers to one or more spectral distribution characteristics used to characterize contact stability between the wheel and the road surface. For example, the frequency domain feature may include a high-frequency oscillation feature, a low-frequency stationary feature, etc.

In some embodiments, the vehicle terminal may transform the normal force sequence within the set time window through a Fast Fourier Transform (FFT) to obtain a spectrogram of the normal force sequence; and perform energy integration calculation on the spectrogram to determine a high-frequency band proportion and a low-frequency band proportion. When the high-frequency band proportion in the spectrogram is greater than the low-frequency band proportion, the frequency domain feature is the high-frequency oscillation feature; when the low-frequency band proportion in the spectrogram is greater than the high-frequency band proportion, the frequency domain feature is the low-frequency stationary feature.

The high-frequency band and the low-frequency band may be preset manually. For example, the high-frequency band may be 10-50 Hz, and the low-frequency band may be 0-10 Hz. The high-frequency band proportion refers to a ratio of energy of the high-frequency band to total energy of a full frequency band in the spectrogram. The low-frequency band proportion refers to a ratio of energy of the low-frequency band to the total energy.

In some embodiments, the vehicle terminal may determine the confidence level by querying a first preset table based on the frequency domain feature and the slip ratio.

The first preset table includes correspondences among frequency domain features, slip ratios, and confidence levels. The first preset table may be constructed based on historically collected data with a good confidence level determination effect. One piece of historically collected data includes a historical frequency domain feature and a historical slip ratio of a historical wheel, and a historical actual confidence level of a historical adhesion coefficient corresponding to the historically collected data.

In some embodiments, the vehicle terminal may perform weighted fusion on a plurality of historical adhesion coefficients corresponding to a plurality of pieces of historically collected data within a same historical grid area, using respective normalized historical actual confidence levels as weights, to obtain an adhesion coefficient inversion value of the historical grid area; and mark the historically collected data corresponding to a historical grid area where a deviation (e.g., an absolute value of a difference) between the adhesion coefficient inversion value and an adhesion coefficient standard value is within a preset tolerance range as the historically collected data with a good confidence level determination effect. The adhesion coefficient standard value may be represented by an actual adhesion coefficient of the historical grid area measured by a high-precision standard instrument or a professional road friction coefficient test vehicle. The preset tolerance range may be preset manually, for example, less than 0.1. The normalization processing manner includes but is not limited to max-min normalization, etc.

In some embodiments of the present disclosure, by determining the confidence level of the adhesion coefficient based ob the frequency domain feature of the normal force sequence and the slip ratio, the accuracy of judging the degree of reliability with which the adhesion coefficient reflects a true limit friction capability is improved, and the risk of misjudgment in determining the adhesion coefficient is effectively reduced.

Step 230, obtaining, by the management platform via the vehicle-road cooperative network, vehicle travel information of each of the plurality of vehicle terminals, a plurality of adhesion coefficients corresponding to a plurality of wheels, and a plurality of confidence levels of the plurality of adhesion coefficients.

The vehicle travel information refers to basic information related to vehicle travel, for example, a vehicle ID (e.g., a license plate number), a vehicle position, and a travel moment.

The vehicle position refers to position coordinates of the vehicle in a high-precision map space. In some embodiments, the vehicle position may be collected by a positioning module (e.g., a GPS positioning system) of the vehicle terminal. The high-precision map space may be an actual three-dimensional geographic space.

The travel moment refers to an acquisition moment of a set of adhesion coefficients corresponding to the vehicle. The set of adhesion coefficients corresponding to the vehicle includes the plurality of adhesion coefficients corresponding to the plurality of wheels of the vehicle acquired at the same time.

In some embodiments, the plurality of vehicle terminals upload the vehicle travel information, the plurality of adhesion coefficients corresponding to the plurality of wheels, and the plurality of confidence levels of the plurality of adhesion coefficients to the management platform via the vehicle-road cooperative network.

Step 240, based on the vehicle travel information of each vehicle terminal, the plurality of adhesion coefficients, and the plurality of confidence levels, determining, by the management platform, a fused adhesion coefficient corresponding to a grid area and transmitting the fused adhesion coefficient to each vehicle terminal. For more content regarding the vehicle travel information, the adhesion coefficients, and the confidence levels, reference may be made to the above description.

The grid area refers to a smallest geographic data unit obtained by discretizing the high-precision map space covering a road on which a vehicle travels according to a preset size. The preset size may be preset manually, for example, 0.5 m×0.5 m.

The fused adhesion coefficient refers to a coefficient reflecting an adhesion capability of a road surface within the grid area. In some embodiments, a value range of the fused adhesion coefficient may be 0 to 1.

In some embodiments, the management platform may continuously collect data from the plurality of vehicle terminals covering different data recording moments, the data including the vehicle travel information of each vehicle terminal at each data recording moment, the plurality of adhesion coefficients, and the plurality of confidence levels corresponding to the plurality of adhesion coefficients. For each vehicle terminal at each data recording moment, the management platform may determine position coordinates of the contact point between the road surface and each wheel corresponding to the vehicle terminal in the high-precision map space based on the vehicle position at the data recording moment and geometric dimensions of the vehicle. All contact points between the road surface and the wheels corresponding to all vehicle terminals at all data recording moments are mapped into the high-precision map space used for dividing grid areas. The management platform may determine all contact points within each grid area. For each grid area, the management platform may normalize the confidence levels of the adhesion coefficients corresponding to all contact points within the grid area, and perform a weighted summation by multiplying the normalized confidence levels with the corresponding adhesion coefficients to obtain a fused adhesion coefficient of the grid area.

In some embodiments, the management platform may obtain the geometric dimensions of the vehicle based on factory information of the vehicle.

In some embodiments, the management platform may further determine a time decay factor based on the vehicle travel information; determine a plurality of fusion weights corresponding to the plurality of adhesion coefficients based on the time decay factor and the plurality of confidence levels; and determine the fused adhesion coefficient by performing a weighted summation on the plurality of adhesion coefficients based on the plurality of fusion weights corresponding to the plurality of adhesion coefficients. For more content regarding this part, reference may be made to FIG. 3 and the related description thereof.

In some embodiments, the management platform may further determine a data transmission parameter corresponding to the grid area based on the fused adhesion coefficient corresponding to the grid area; and perform data transmission with vehicle terminals within the grid area based on the data transmission parameter.

The data transmission parameter refers to a working parameter of data transmission between the management platform and the plurality of vehicle terminals. In some embodiments, the data transmission parameter may include a transmission priority, a count of transmission channels, and a count of bandwidth units.

The transmission priority represents a degree of priority of data transmission. In some embodiments, the transmission priority may be represented by an integer within a range of 1 to 10, wherein a larger numerical value indicates a higher priority.

The count of transmission channels represents a path scale of data transmission. In some embodiments, the greater the count of transmission channels, the larger the data transmission scale.

The count of bandwidth units represents a communication resource scale allocated to data transmission. In some embodiments, the greater the count of bandwidth units, the faster a data transmission speed.

In some embodiments, the management platform may determine the data transmission parameter through a preset relationship based on the fused adhesion coefficient. The preset relationship may be pre-constructed manually. For example, the lower the fused adhesion coefficient of a grid area, the higher the transmission priority of the grid area, and the greater the count of transmission channels and the count of bandwidth units.

In some embodiments, the management platform may preferentially allocate more transmission channels and more bandwidth units to a grid area with a high transmission priority to perform data transmission.

In some embodiments, the management platform may transmit the fused adhesion coefficient corresponding to the grid area to each vehicle terminal based on the data transmission parameter.

In some embodiments of the present disclosure, by dynamically adjusting the data transmission parameter based on the fused adhesion coefficient of the grid area, on-demand allocation of resources is achieved under limited communication resources, data backhaul requirements of areas with higher driving risks are preferentially guaranteed, active warning efficiency and coverage integrity of overall road conditions are improved, and the problem of network congestion during concurrent communication of multiple vehicles is solved.

Step 250, determining, by each of the plurality of vehicle terminals, a target travel speed of the vehicle based on the fused adhesion coefficient, and driving the vehicle to a target travel speed within a target time.

The target travel speed refers to a safe travel speed suitable for a current road surface adhesion condition.

In some embodiments, the vehicle terminal may determine the target travel speed by looking up a second preset table based on the fused adhesion coefficient. The second preset table includes correspondences between fused adhesion coefficients and target travel speeds. For example, the target travel speed and the fused adhesion coefficient are positively correlated. In some embodiments, the second preset table may be pre-constructed manually based on historical experience.

The target time refers to a preset time period required to drive the vehicle to the target travel speed. In some embodiments, the vehicle terminal may determine the target time based on a current speed of the vehicle, the target travel speed, and the fused adhesion coefficient by Formula (6):

$${T}_{target} = \frac{\vert {V}_{current} - {V}_{target} \vert}{a \times {U}_{fuse}} , \qquad ( 6 )$$

wherein T_{target} represents the target time, V_{current} represents the current speed of the vehicle, V_{target} represents the target travel speed of the vehicle, a represents a reference acceleration of the vehicle (reflecting an acceleration/deceleration capability of the vehicle itself, determined by vehicle performance and configuration), and U_{fuse} represents the fused adhesion coefficient.

In some embodiments, the current speed of the vehicle may be directly collected and acquired by a sensor of the vehicle terminal, and the reference acceleration a of the vehicle may be pre-uploaded manually.

In some embodiments, the vehicle terminal may control an in-wheel motor, a steering motor, etc., through a control module to control the vehicle to drive from the current speed of the vehicle to the target travel speed of the vehicle.

In some embodiments of the present disclosure, by determining the adhesion coefficient based on the multi-dimensional mechanical data, determining the confidence level of the adhesion coefficient based on the slip ratio, uploading data utilizing the vehicle-road cooperative network, and determining the fused adhesion coefficient by the management platform, quantitative sensing of a road surface adhesion state and multi-source data fusion are realized; and the target travel speed of the vehicle is determined based on the fused adhesion coefficient, thereby effectively ensuring driving safety.

FIG. 3 is a flowchart of an exemplary process for determining a fused adhesion coefficient according to some embodiments of the present disclosure. In some embodiments, as shown in FIG. 3, a process 300 may include steps 310 to 330, and steps 310 to 330 may be performed by a management platform (e.g., the management platform 110).

Step 310, determining a time decay factor based on vehicle travel information. For more content regarding the vehicle travel information, reference may be made to FIG. 2 and the related description thereof.

The time decay factor refers to a numerical coefficient that gradually decreases as time elapses. In some embodiments, a value range of the time decay factor may be 0 to 1.

In some embodiments, the management platform may calculate a time interval between a travel moment and a current moment based on the travel moment in the vehicle travel information; and determine the time decay factor corresponding to the vehicle travel information based on the time interval by the following Formula (7):

λ(Δt)=e^{-α·Δt} (7),

wherein λ(Δt) denotes the time decay factor of the travel moment, Δt denotes the time interval between the travel moment and the current moment, and α is a decay rate constant. In some embodiments, α may be set by the management platform or manually based on historical experience.

Step 320, determining a plurality of fusion weights corresponding to a plurality of adhesion coefficients based on the time decay factor and a plurality of confidence levels.

In some embodiments, for each adhesion coefficient at the travel moment, the management platform may determine an initial weight of the adhesion coefficient based on the following Formula (8); and normalize the initial weights of the plurality of adhesion coefficients corresponding to a plurality of wheels to obtain the fusion weight of each adhesion coefficient. Formula (8) is as follows:

Wᵢₙᵢₜᵢₐₗ=W_{conf}·λ(Δt) (8),

wherein W_{conf} denotes the confidence level of the adhesion coefficient, and Wᵢₙᵢₜᵢₐₗ denotes the initial weight of the adhesion coefficient. For more content regarding the confidence level of the adhesion coefficient, reference may be made to FIG. 2 and the related description thereof.

Step 330, determining the fused adhesion coefficient by performing a weighted summation on the plurality of adhesion coefficients based on the plurality of fusion weights corresponding to the plurality of adhesion coefficients.

In some embodiments, for each grid area, the management platform may perform a weighted calculation on the plurality of adhesion coefficients corresponding to a plurality of contact points between a plurality of wheels and a road surface within the grid area based on the plurality of fusion weights corresponding to the plurality of adhesion coefficients, to obtain the fused adhesion coefficient of the grid area.

In some embodiments, the vehicle travel information further includes a plurality of tire properties corresponding to the plurality of wheels, and for each wheel, the management platform may further determine an equivalent adhesion coefficient through a coupling conversion model based on the adhesion coefficient and the tire property corresponding to the wheel; and determine the fused adhesion coefficient by performing a weighted summation on a plurality of equivalent adhesion coefficients corresponding to the plurality of adhesion coefficients based on the plurality of fusion weights corresponding to the plurality of adhesion coefficients.

The tire property refers to a physical parameter that affects a friction effect between the wheel and the road surface. In some embodiments, the tire property may include a tire type and a tire wear degree. The tire type may be classified, according to applicable scenarios of a tire of the wheel, into a summer tire, a winter tire, an all-season tire, a run-flat tire, etc. The tire wear degree may be classified, according to a tire tread depth, into almost unworn, semi-worn, and severely worn.

In some embodiments, when the vehicle is started, the management platform may automatically read an electronic tag in a tire chip through a wheel speed sensor to identify the tire type.

In some embodiments, the management platform may determine the tire wear degree based on a tire tread depth measured by a tread depth sensor. For example, when the tire tread depth is greater than 6 mm, the tire wear degree is almost unworn; when the tire tread depth is 3 mm to 6 mm, the tire wear degree is semi-worn; when the tire tread depth is less than 1.6 mm, the tire wear degree is severely worn.

The coupling conversion model refers to a mathematical model that converts the adhesion coefficients measured on a current road surface by wheels with different tire properties into equivalent adhesion coefficients.

In some embodiments, the management platform may construct the coupling conversion model based on experimental data. For example, a real vehicle experiment is conducted on a standard test site, and an experimental vehicle may be configured with a standard reference tire and a plurality of experimental tires with different tire properties. During travel of the experimental vehicle, a friction coefficient of the standard reference tire and a friction coefficient of each experimental tire are measured through sensors configured on wheels of the experimental vehicle. For each experimental tire, a ratio of the friction coefficient of the standard reference tire to the friction coefficient of the experimental tire is determined as a correction coefficient corresponding to the tire property corresponding to the experimental tire. The coupling conversion model includes a plurality of correction coefficients corresponding to the plurality of tire properties. The standard reference tire refers to a pre-designated single tire with a specific specification, for example, a standard ASTM E1136 reference test tire or a brand-new summer tire of a designated model.

The correction coefficient refers to a coefficient used to correct the adhesion coefficient.

The equivalent adhesion coefficient refers to a theoretical adhesion coefficient that the tire should have on the current road surface.

In some embodiments, for each wheel, the management platform may input the adhesion coefficient and the tire property into the coupling conversion model, the coupling conversion model automatically searches for the correction coefficient corresponding to the tire property, multiplies the adhesion coefficient by the correction coefficient, and outputs the equivalent adhesion coefficient.

In some embodiments, for each grid area, the management platform may perform a weighted calculation on the plurality of equivalent adhesion coefficients corresponding to the plurality of adhesion coefficients based on the plurality of fusion weights corresponding to the plurality of adhesion coefficients of a plurality of contact points between wheels and a road surface within the grid area, to obtain the fused adhesion coefficient.

In some embodiments of the present disclosure, by determining the equivalent adhesion coefficients using the coupling conversion model and performing weighted fusion, the accuracy of the fused adhesion coefficient is improved. Data deviations caused by differences in tire properties are eliminated, and it is possible to avoid a situation in which adhesion coefficients generated by a vehicle with a relatively high adhesion capability mislead other vehicles into entering an area with a relatively high driving risk.

In some embodiments of the present disclosure, by introducing a time decay mechanism, the timeliness problem of road surface states changing over time is solved, and the real-time performance of the fused adhesion coefficient is improved.

In some embodiments, after determining the fused adhesion coefficient, the management platform may further generate warning information and deliver the warning information to the plurality of vehicle terminals.

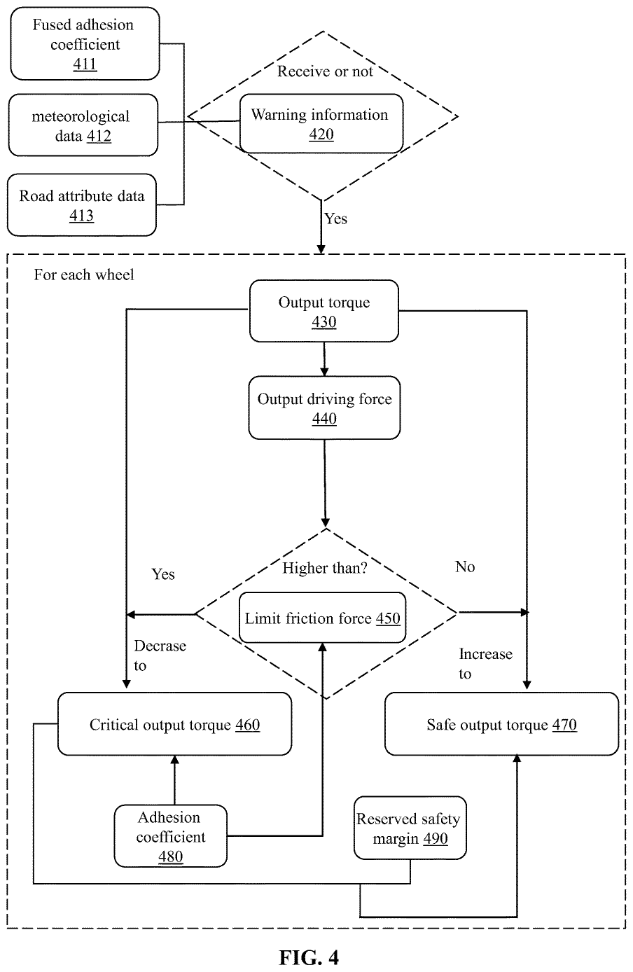

FIG. 4 is an exemplary schematic diagram of a subsequent processing flow after receiving warning information according to some embodiments of the present disclosure.

In some embodiments, as shown in FIG. 4, a management platform (e.g., the management platform 110) may determine warning information 420 based on a fused adhesion coefficient 411, meteorological data 412, and road attribute data 413, and transmit the warning information 420 to each of a plurality of vehicle terminals. Each of the plurality of vehicle terminals receives the warning information 420 and the fused adhesion coefficient 411. For a wheel corresponding to each of the plurality of vehicle terminals, the vehicle terminal determines an output driving force 440 of the wheel based on an output torque 430 of an in-wheel motor of the wheel; determines a limit friction force 450 of a contact point between the wheel and a road surface and a critical output torque 460 corresponding to the limit friction force 450 based on the adhesion coefficient 480. Each vehicle terminal further determines a safe output torque 470 based on the critical output torque 460 and a reserved safety margin 490. In response to the output driving force 440 being higher than the limit friction force 450, the vehicle terminal controls the output torque 430 to decrease to the critical output torque 460. In response to the output driving force 440 being lower than the limit friction force 450, the vehicle terminal controls the output torque 430 to increase to the safe output torque 470.

For more content regarding the fused adhesion coefficient, the adhesion coefficient, and the contact point between the wheel and the road surface, reference may be made to FIG. 2 and the related description thereof.

The meteorological data may include an ambient temperature, a wind speed, a precipitation intensity, etc. In some embodiments, the management platform may obtain the meteorological data through a third-party platform (e.g., a weather forecast APP) based on a vehicle-road cooperative network.

The road attribute data refers to inherent attribute parameters of a road on which the vehicle travels, for example, a slope, a curvature, a count of lanes, a road surface material, etc. In some embodiments, the management platform may obtain the road attribute data of the road on which the vehicle travels based on a C-V2X communication protocol via the vehicle-road cooperative network. For more related content regarding the C-V2X communication protocol and the vehicle-road cooperative network, reference may be made to the related description of FIG. 1.

The warning information refers to a comprehensive road condition alert for vehicles in a target area. The warning information may include a recommended lane (e.g., “Please use the left lane”) and/or speed limit information (e.g., “Recommended speed not exceeding 40 km/h”). In some embodiments, the warning information may further integrate the meteorological data and the road attribute data, for example, “The road surface is icy on a sharp curve and downhill section 500 meters ahead, accompanied by crosswind. A speed below 40 km/h and driving in the left lane are recommended.” The target area refers to an area where road surface maintenance operations are required. In some embodiments, the management platform may identify a grid area having a fused adhesion coefficient lower than a preset threshold as the target area, wherein the preset threshold is manually set.

In some embodiments, the management platform may identify a grid area in the target area where the fused adhesion coefficient is lower than a preset safety threshold as a low-adhesion area, and automatically generate the warning information based on the road attribute data and the meteorological data of the low-adhesion area. The preset safety threshold id less than the preset threshold, and is manually set.

The output torque refers to a driving torque applied by the in-wheel motor to the wheel. In some embodiments, each vehicle terminal may acquire the output torque corresponding to the wheel associated with the vehicle terminal in real time through an MCU.

The output driving force refers to a driving force generated by the wheel acting on the road surface under the action of the output torque.

In some embodiments, for each wheel, the corresponding vehicle terminal may determine the output driving force of the wheel based on the output torque of the in-wheel motor of the wheel by the following Formula (9):

$$F = \frac{O}{r} , \qquad ( 9 )$$

wherein F denotes the output driving force, O denotes the output torque, and r denotes a wheel radius.

In some embodiments, the vehicle terminal may automatically read an electronic tag in a tire chip through a wheel speed sensor to identify the wheel radius.

The limit friction force refers to a maximum friction force that the contact point between the wheel and the road surface can provide.

The critical output torque refers to a maximum driving torque output by the in-wheel motor to ensure that the wheel does not slip.

In some embodiments, for each wheel, the corresponding vehicle terminal may determine the limit friction force of the contact point between the wheel and the road surface and the critical output torque corresponding to the limit friction force based on the adhesion coefficient by the following Formulas (10) and (11):

Fₗᵢₘᵢₜ=μ·F_{z} (10),

C=Fₗᵢₘᵢₜ·r (11),

wherein Fₗᵢₘᵢₜ denotes the limit friction force, C denotes the critical output torque corresponding to the limit friction force Fₗᵢₘᵢₜ, for F_{z}, reference may be made to the related description of Formula (2), for u, reference may be made to the related description of Formula (4), and for r, reference may be made to the related description of Formula (9).

The reserved safety margin refers to a safety control margin reserved on the basis of the critical output torque.

The safe output torque refers to a maximum driving torque set for the in-wheel motor to ensure driving safety. In some embodiments, the vehicle terminal may use an output torque obtained by subtracting the reserved safety margin from the critical output torque as the safe output torque.

In some embodiments, when the output driving force is greater than the limit friction force, it indicates that the driving force of the wheel has exceeded a maximum friction force that the current road surface can provide, and there is a risk of slipping. The vehicle terminal may clamp the output torque at the critical output torque to restore tire grip and prevent loss of control due to spinning.

In some embodiments, when the output driving force is less than the limit friction force, it indicates that the driving force of the wheel is less than the maximum friction force that the current road surface can provide. The vehicle terminal may increase the output torque to the safe output torque, thereby avoiding slipping while ensuring the driving force, so as to smoothly pass through the low-adhesion area.

In some embodiments of the present disclosure, by dynamically adjusting the output torque of each wheel based on the fused adhesion coefficient, active control of the driving torque is realized, the risk of slipping is effectively reduced while the power demand is ensured, and driving safety under complex road conditions such as split-friction road surfaces is improved.

The basic concepts have been described above. Obviously, for those skilled in the art, the detailed disclosure above is merely illustrative and does not constitute a limitation on the present disclosure. Although not explicitly stated, those skilled in the art may make various modifications, improvements, and corrections to the present disclosure. Such modifications, improvements, and corrections are suggested within the present disclosure and thus remain within the spirit and scope of the exemplary embodiments of the present disclosure.

Meanwhile, the present disclosure uses specific terms to describe the embodiments herein. Terms such as “one embodiment,” “an embodiment,” and/or “some embodiments” mean that a certain feature, structure, or characteristic related to at least one embodiment of the present disclosure. Therefore, it is emphasized and noted that the terms “an embodiment,” “one embodiment,” or “an alternative embodiment” mentioned two or more times at different locations in the present disclosure do not necessarily refer to the same embodiment. Furthermore, certain features, structures, or characteristics in one or more embodiments of the present disclosure may be appropriately combined.

Furthermore, unless explicitly stated in the claims, the order of processing elements and sequences, the use of numbers or letters, or the use of other names in the present disclosure is not intended to limit the order of the processes and methods described herein. Although the foregoing disclosure discusses some currently considered useful inventive embodiments through various examples, it should be understood that such details are for illustrative purposes only, and the appended claims are not limited to the disclosed embodiments. On the contrary, the claims are intended to cover all modifications and equivalent combinations that conform to the essence and scope of the embodiments of the present disclosure. For example, although the system components described above may be implemented via hardware devices, they may also be realized solely through software solutions, such as installing the described system on existing servers or mobile devices.

Similarly, it should be noted that to simplify the presentation of the present disclosure and thereby aid in understanding one or more inventive embodiments, in the descriptions of the embodiments of the present disclosure above, various features may sometimes be grouped into a single embodiment, figure, or description thereof. However, this disclosure manner does not imply that the subject matter of the present disclosure requires more features than those mentioned in the claims. In fact, the features of an embodiment are fewer than all the features of a single embodiment disclosed above.

In some embodiments, numbers describing quantities or attributes are used. It should be understood that such numbers used in the description of the embodiments may, in some examples, be modified by the terms “approximately,” “about,” or “substantially.” Unless otherwise specified, “approximately,” “about,” or “substantially” indicates that the stated number allows for a variation of ±20%. Accordingly, in some embodiments, the numerical parameters used in the specification and claims are approximations, which may vary depending on the characteristics required by individual embodiments. In some embodiments, numerical parameters should consider the specified number of significant digits and adopt the method of general digit retention. Although the numerical ranges and parameters used to confirm their breadth in some embodiments of the present disclosure are approximations, in specific embodiments, such numerical values are set as accurately as possible within the feasible range.

For each patent, patent application, patent application publication, and other material, such as articles, books, specifications, publications, documents, etc., cited in the present disclosure, the entire content thereof is hereby incorporated by reference into the present disclosure. Excluded are application history documents that are inconsistent or conflict with the content of the present disclosure, and documents that limit the broadest scope of the claims of the present disclosure (whether currently or subsequently appended to the present disclosure). It should be noted that if the description, definition, and/or use of terms in the supplementary materials of the present disclosure are inconsistent or conflict with those in the present disclosure, the description, definition, and/or use of terms in the present disclosure shall prevail.

Finally, it should be understood that the embodiments described in the present disclosure are merely illustrative of the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those explicitly introduced and described herein.

What is claimed is:

1. An Internet of Things (IoT) system for dynamic inversion of road friction based on multiple sensors, comprising a management platform, a vehicle-road cooperative network, and a plurality of vehicle terminals, wherein
each of the plurality of vehicle terminals is configured to:
for each wheel corresponding to the vehicle terminal,
determine an adhesion coefficient of a contact point between the wheel and a road surface based on multi-dimensional mechanical data of the wheel; and
determine a confidence level of the adhesion coefficient based on a slip ratio of the wheel; and
the management platform is configured to:
obtain, via the vehicle-road cooperative network, vehicle travel information of each of the plurality of vehicle terminals, a plurality of adhesion coefficients corresponding to a plurality of wheels, and a plurality of confidence levels of the plurality of adhesion coefficients; and
determine, based on the vehicle travel information of the plurality of vehicle terminals, the plurality of adhesion coefficients, and the plurality of confidence levels, a fused adhesion coefficient corresponding to a grid area and transmit the fused adhesion coefficient to each of the plurality of vehicle terminals; and
each of the plurality of vehicle terminals is further configured to:
determine a target travel speed of a vehicle based on the fused adhesion coefficient, and drive the vehicle to the target travel speed within a target time.

2. The IoT system of claim 1, wherein each of the plurality of vehicle terminals is further configured to:
obtain a pitch angle and a roll angle of the vehicle;
establish a coordinate rotation matrix of the vehicle based on the pitch angle and the roll angle; and
correct the multi-dimensional mechanical data based on the coordinate rotation matrix.

3. The IoT system of claim 1, wherein each of the plurality of vehicle terminals is further configured to:
for each wheel corresponding to the vehicle terminal,
control an in-wheel motor of the wheel to apply an excitation torque;
obtain a frequency response characteristic of a wheel speed of the wheel to the excitation torque based on the excitation torque; and
determine the adhesion coefficient based on the multi-dimensional mechanical data and the frequency response characteristic.

4. The IoT system of claim 1, wherein the management platform is further configured to:
determine a data transmission parameter corresponding to the grid area based on the fused adhesion coefficient corresponding to the grid area; and
perform data transmission with vehicle terminals within the grid area based on the data transmission parameter.

5. The IoT system of claim 1, wherein each of the plurality of vehicle terminals is further configured to:
for each wheel corresponding to the vehicle terminal,
perform a frequency domain analysis on a normal force sequence to determine a frequency domain feature; and
determine the confidence level based on the frequency domain feature and the slip ratio.

6. The IoT system of claim 1, wherein the management platform is further configured to:
determine a time decay factor based on the vehicle travel information;
determine a plurality of fusion weights corresponding to the plurality of adhesion coefficients based on the time decay factor and the plurality of confidence levels; and
determine the fused adhesion coefficient by performing a weighted summation on the plurality of adhesion coefficients based on the plurality of fusion weights corresponding to the plurality of adhesion coefficients.

7. The IoT system of claim 6, wherein the vehicle travel information further includes a plurality of tire properties corresponding to the plurality of wheels, and the management platform is further configured to:
for each of the plurality of wheels, determine an equivalent adhesion coefficient through a coupling conversion model based on the adhesion coefficient and the tire property corresponding to the wheel; and
determine the fused adhesion coefficient by performing a weighted summation on a plurality of equivalent adhesion coefficients corresponding to the plurality of adhesion coefficients based on the plurality of fusion weights corresponding to the plurality of adhesion coefficients.

8. The IoT system of claim 1, wherein the management platform is further configured to:
determine warning information based on the fused adhesion coefficient, meteorological data, and road attribute data;
each of the plurality of vehicle terminals is further configured to:
receive the warning information and the fused adhesion coefficient;
for each wheel corresponding to the vehicle terminal,
determine an output driving force of the wheel based on an output torque of an in-wheel motor of the wheel;
determine a limit friction force of the contact point between the wheel and the road surface and a critical output torque corresponding to the limit friction force based on the adhesion coefficient;
determine a safe output torque based on the critical output torque and a reserved safety margin;
in response to the output driving force being higher than the limit friction force, control the output torque to decrease to the critical output torque; and
in response to the output driving force being lower than the limit friction force, control the output torque to increase to the safe output torque.

9. A method for dynamic inversion of road friction based on an Internet of Things (IoT) and multiple sensors, the method being performed by an IoT system for dynamic inversion of road friction based on multiple sensors, the system comprising a management platform, a vehicle-road cooperative network, and a plurality of vehicle terminals; the method comprising:
performing, by each of the plurality of vehicle terminals, operations including:
for each wheel corresponding to the vehicle terminal,
determining an adhesion coefficient of a contact point between the wheel and a road surface based on multi-dimensional mechanical data of the wheel; and
determining a confidence level of the adhesion coefficient based on a slip ratio of the wheel;
performing, by the management platform, operations including:
obtaining, via the vehicle-road cooperative network, vehicle travel information of each of the plurality of vehicle terminals, a plurality of adhesion coefficients corresponding to a plurality of wheels, and a plurality of confidence levels of the plurality of adhesion coefficients; and
determining, based on the vehicle travel information of each of the plurality of vehicle terminals, the plurality of adhesion coefficients, and the plurality of confidence levels, a fused adhesion coefficient corresponding to a grid area and transmitting the fused adhesion coefficient to each of the plurality of vehicle terminals; and
performing, by each of the plurality of vehicle terminals, operations including:
determining a target travel speed of a vehicle based on the fused adhesion coefficient, and driving the vehicle to the target travel speed within a target time.

10. The method of claim 9, further comprising:
performing, by each of the plurality of vehicle terminals, operations including:
obtaining a pitch angle and a roll angle of the vehicle;
establishing a coordinate rotation matrix of the vehicle based on the pitch angle and the roll angle; and
correcting the multi-dimensional mechanical data based on the coordinate rotation matrix.

11. The method of claim 9, wherein the determining an adhesion coefficient of a contact point between the wheel and a road surface based on multi-dimensional mechanical data of the wheel includes:
controlling an in-wheel motor of the wheel to apply an excitation torque;
obtaining a frequency response characteristic of a wheel speed of the wheel to the excitation torque based on the excitation torque; and
determining the adhesion coefficient based on the multi-dimensional mechanical data and the frequency response characteristic.

12. The method of claim 9, further comprising:
performing, by the management platform, operations including:
determining a data transmission parameter corresponding to the grid area based on the fused adhesion coefficient corresponding to the grid area; and
performing data transmission with vehicle terminals within the grid area based on the data transmission parameter.

13. The method of claim 9, wherein the determining a confidence level of the adhesion coefficient based on a slip ratio of the wheel includes:
performing a frequency domain analysis on a normal force sequence to determine a frequency domain feature; and
determining the confidence level based on the frequency domain feature and the slip ratio.

14. The method of claim 9, wherein the determining, based on the vehicle travel information of each of the plurality of vehicle terminals, the plurality of adhesion coefficients, and the plurality of confidence levels, a fused adhesion coefficient corresponding to a grid area includes:
determining a time decay factor based on the vehicle travel information;
determining a plurality of fusion weights corresponding to the plurality of adhesion coefficients based on the time decay factor and the plurality of confidence levels; and
determining the fused adhesion coefficient by performing a weighted summation on the plurality of adhesion coefficients based on the plurality of fusion weights corresponding to the plurality of adhesion coefficients.

15. The method of claim 14, wherein the vehicle travel information further includes a plurality of tire properties corresponding to the plurality of wheels, and determining the fused adhesion coefficient by performing a weighted summation on the plurality of adhesion coefficients based on the plurality of fusion weights corresponding to the plurality of adhesion coefficients includes:
for each of the plurality of wheels, determining an equivalent adhesion coefficient through a coupling conversion model based on the adhesion coefficient and the tire property corresponding to the wheel; and
determining the fused adhesion coefficient by performing a weighted summation on a plurality of equivalent adhesion coefficients corresponding to the plurality of adhesion coefficients based on the plurality of fusion weights corresponding to the plurality of adhesion coefficients.

16. The method of claim 9, further comprising:
performing, by the management platform, operations including:
determining warning information based on the fused adhesion coefficient, meteorological data, and road attribute data, and transmitting the warning information to each of the plurality of vehicle terminals; and
performing, by each of the plurality of vehicle terminals, operations including:
receiving the warning information and the fused adhesion coefficient; and
for each wheel corresponding to the vehicle terminal,
determining an output driving force of the wheel based on an output torque of an in-wheel motor of the wheel;
determining a limit friction force of the contact point between the wheel and the road surface and a critical output torque corresponding to the limit friction force based on the adhesion coefficient;
determining a safe output torque based on the critical output torque and a reserved safety margin;
in response to the output driving force being higher than the limit friction force, controlling the output torque to decrease to the critical output torque; and
in response to the output driving force being lower than the limit friction force, controlling the output torque to increase to the safe output torque.
